(19) United States
(12) Patent Application Publication
(10) Pub. No.: US 2011/0268085 A1
(43) Pub. Date: Nov. 3, 2011

(54) LTE FORWARD HANDOVER

(75) Inventors: Peter A. Barany, San Diego, CA (US); Ajay Gupta, San Diego, CA (US); Brian Spinar, Poway, CA (US); Abhijit S. Khobare, San Diego, CA (US)

(73) Assignee: QUALCOMM Incorporated, San Diego, CA (US)

(21) Appl. No.: 12/949,701

(22) Filed: Nov. 18, 2010

Related U.S. Application Data
(60) Provisional application No. 61/262,892, filed on Nov. 19, 2009.
(60) Provisional application No. 61/298,171, filed on Jan. 25, 2010.

(51) Int. Cl. H04W 36/00

(52) U.S. Cl. 370/331

(57) ABSTRACT

Techniques for performing forward handover in a wireless communication system are disclosed. In one aspect, a user equipment (UE) transmits a connection request to a target eNodeB. The connection request may be transmitted when the UE detects a connection failure in a communication with a source eNodeB. The UE receives a connection response from the target eNodeB in response to the target eNodeB requesting handover preparation information from the source eNodeB. In another aspect, a target eNodeB may receive a connection request from a user equipment (UE) and transmit a radio link failure (RLF) recovery request message to a source eNodeB to prompt the source eNodeB to initiate handover of the UE from the source eNodeB.

### CROSS REFERENCE TO RELATED APPLICATIONS

This application claims the benefit of U.S. Provisional Patent Application No. 61/262,892, entitled “LTE Forward Handover,” filed on Nov. 19, 2009, and U.S. Provisional Patent Application No. 61/298,171, entitled “Optimization for System Information Acquisition During Radio Link Failure for LTE,” filed on Jan. 25, 2010, the disclosures of which are expressly incorporated by reference herein in their entireties.

### BACKGROUND

1. Field

Aspects of the present disclosure relate generally to wireless communication systems, and more particularly to a LTE forward handover system and method.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

In one embodiment, a method of wireless communication is disclosed. The method includes transmitting a connection request to a target eNodeB. The method also includes receiving a connection response from the target eNodeB in response to the target eNodeB requesting handover preparation information from a source eNodeB.

In an embodiment, an apparatus for wireless communication is disclosed. The apparatus includes at least one processor and a memory coupled to the at least one processor. The at least one processor is configured to transmit a connection request to a target eNodeB. The processor receives a connection response from the target eNodeB in response to the target eNodeB requesting handover preparation information from a source eNodeB.

In another embodiment a system for wireless communication is disclosed. The system includes a means for transmitting a connection request to a target eNodeB and a means for receiving a connection response from the target eNodeB in response to the target eNodeB requesting handover preparation information from a source eNodeB.

A further embodiment discloses a computer program product for wireless communications in a wireless network. The computer-readable medium has program code recorded thereon which, when executed by one or more processors, causes the processor(s) to transmit a connection request to a target eNodeB. The program code also causes the processor(s) to receive a connection response from the target eNodeB in response to the target eNodeB requesting handover preparation information from a source eNodeB.

In another embodiment, a method of wireless communication is disclosed. The method includes receiving a connection request from a UE. The method also includes transmitting a radio link failure recovery request message to a source eNodeB to prompt the source eNodeB to initiate handover of the UE from the source eNodeB.

A further embodiment discloses an apparatus for wireless communication. The apparatus includes at least one processor and a memory coupled to the at least one processor. The at least one processor is configured to receive a connection request from a UE. The processor transmits a radio link failure recovery request message to a source eNodeB to prompt the source eNodeB to initiate handover of the UE from the source eNodeB.

Another embodiment discloses a system for wireless communication. The system includes a means for receiving a connection request from a UE and a means for transmitting a radio link failure recovery request message to a source eNodeB to prompt the source eNodeB to initiate handover of the UE from the source eNodeB.

In another embodiment, a computer program product for wireless communications in a wireless network is disclosed. The computer-readable medium has program code recorded thereon which, when executed by one or more processors, cause the processor(s) to receive a connection request from a UE. The program code also causes the processor(s) to transmit a radio link failure recovery request message to a source eNodeB to prompt the source eNodeB to initiate handover of the UE from the source eNodeB.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a mobile communication system.

FIG. 2 is a block diagram conceptually illustrating an example of a downlink frame structure in a mobile communication system.

FIG. 3 is a block diagram conceptually illustrating an exemplary frame structure in uplink communications.

FIG. 4 is a block diagram conceptually illustrating a design of a base station/eNodeB and a UE configured according to one aspect of the present disclosure.

FIG. 5 illustrates an example system that performs forward handover from a source eNodeB to a target eNodeB.

FIGS. 6A-C are example call flow diagrams illustrating an access procedure related to successful and unsuccessful forward handovers of a UE to a target access point.

FIG. 7 illustrates an example system that facilitates forward handover in wireless communications.

FIGS. 8A and 8B are timing diagrams illustrating system information acquisition during handover.

FIG. 9 is a block diagram illustrating a method of forward handover.

FIG. 10 is a block diagram illustrating a method of forward handover.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

The techniques described herein may be used for various wireless communication networks such as CDMA, TDMA, FDMA, OFDMA, SC-FDMA and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for LTE or LTE-A (together referred to in the alternative as “LTE/-A”) and use such LTE/-A terminology in much of the description below.

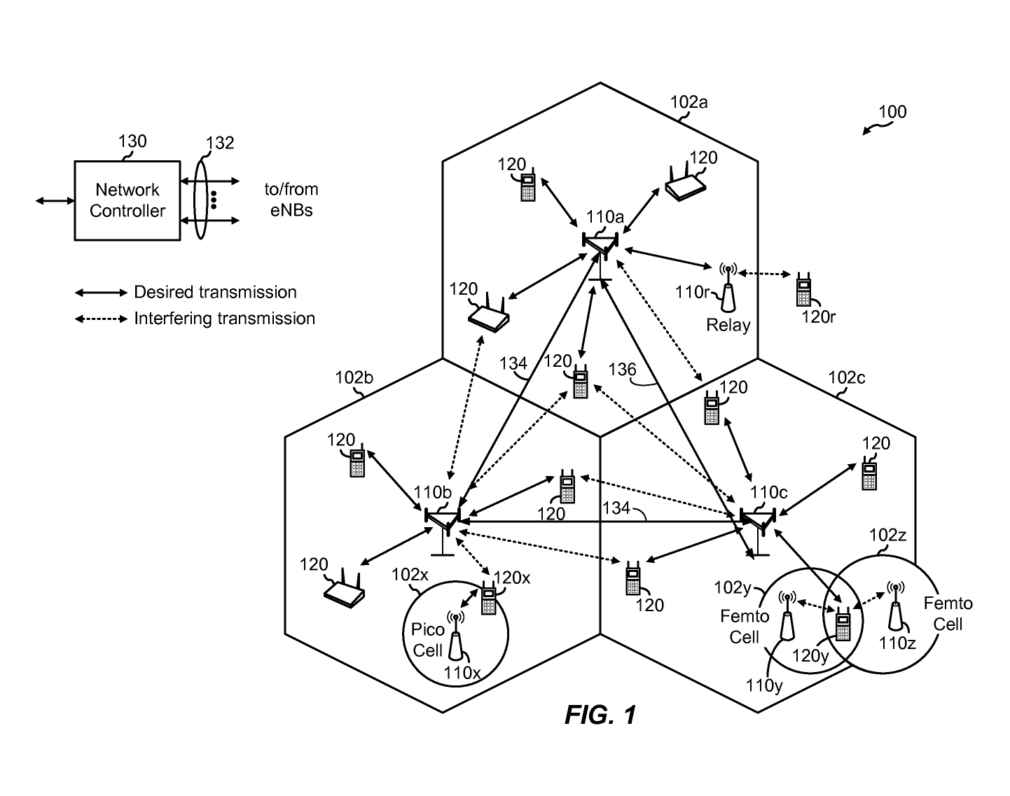

FIG. 1 shows a wireless communication network 100, which may be an LTE-A network. The wireless network 100 includes a number of evolved node Bs (eNodeBs) 110 and other network entities. An eNodeB may be a station that communicates with the UEs and may also be referred to as a base station, a node B, an access point, and the like. Each eNodeB 110 may provide communication coverage for a particular geographic area. In 3GPP, the term “cell” can refer to this particular geographic coverage area of an eNodeB and/or an eNodeB subsystem serving the coverage area, depending on the context in which the term is used.

An eNodeB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNodeB for a macro cell may be referred to as a macro eNodeB. An eNodeB for a pico cell may be referred to as a pico eNodeB. And, an eNodeB for a femto cell may be referred to as a femto eNodeB or a home eNodeB. In the example shown in FIG. 1, the eNodeBs 110a, 110b and 110c are macro eNodeBs for the macro cells 102a, 102b and 102c, respectively. The eNodeB 110x is a pico eNodeB for a pico cell 102x. And, the eNodeBs 110y and 110z are femto eNodeBs for the femto cells 102y and 102z, respectively. An eNodeB may support one or multiple (e.g., two, three, four, and the like) cells.

The wireless network 100 also includes relay stations. A relay station is a station that receives a transmission of data and/or other information from an upstream station (e.g., an eNodeB, a UE, or the like) and sends a transmission of the data and/or other information to a downstream station (e.g., another UE, another eNodeB, or the like). A relay station may also be a UE that relays transmissions for other UEs. In the example shown in FIG. 1, a relay station 110r may communicate with the eNodeB 110a and a UE 120r, in which the relay station 110r acts as a relay between the two network elements (the eNodeB 110a and the UE 120r) in order to facilitate communication between them. A relay station may also be referred to as a relay eNodeB, a relay, and the like.

The wireless network 100 may support synchronous or asynchronous operation. For synchronous operation, the eNodeBs may have similar frame timing, and transmissions from different eNodeBs may be approximately aligned in time. For asynchronous operation, the eNodeBs may have different frame timing, and transmissions from different eNodeBs may not be aligned in time. The techniques described herein may be used for either synchronous or asynchronous operations.

In one aspect, the wireless network 100 may support Frequency Division Duplex (FDD) or Time Division Duplex (TDD) modes of operation. The techniques described herein may be used for either FDD or TDD mode of operation.

A network controller 130 may couple to a set of eNodeBs 110 and provide coordination and control for these eNodeBs 110. The network controller 130 may communicate with the eNodeBs 110 via a backhaul 132. The eNodeBs 110 may also communicate with one another, e.g., directly or indirectly via a wireless backhaul 134 or a wireline backhaul 136.

The UEs 120 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a laptop computer, a cordless phone, a wireless local loop (WLL) station, or the like. A UE may be able to communicate with macro eNodeBs, pico eNodeBs, femto eNodeBs, relays, and the like. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB. According to an aspect of the present disclosure, a UE 120 communicating with a base station 110a hands over to a base station 110b without the base station 110a first preparing the base station 110b for the handover. Such a handover will be referred to as a “forward handover.”

LTE/-A utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for a corresponding system bandwidth of 1.25, 2.5, 5, 10 or 20 megahertz (MHz), respectively. The system bandwidth may also be partitioned into sub-bands. For example, a sub-band may cover 1.08 MHz (i.e., 6 resource blocks), and there may be 1, 2, 4, 8 or 16 sub-bands for a corresponding system bandwidth of 1.25, 2.5, 5, 10 or 20 MHz, respectively.

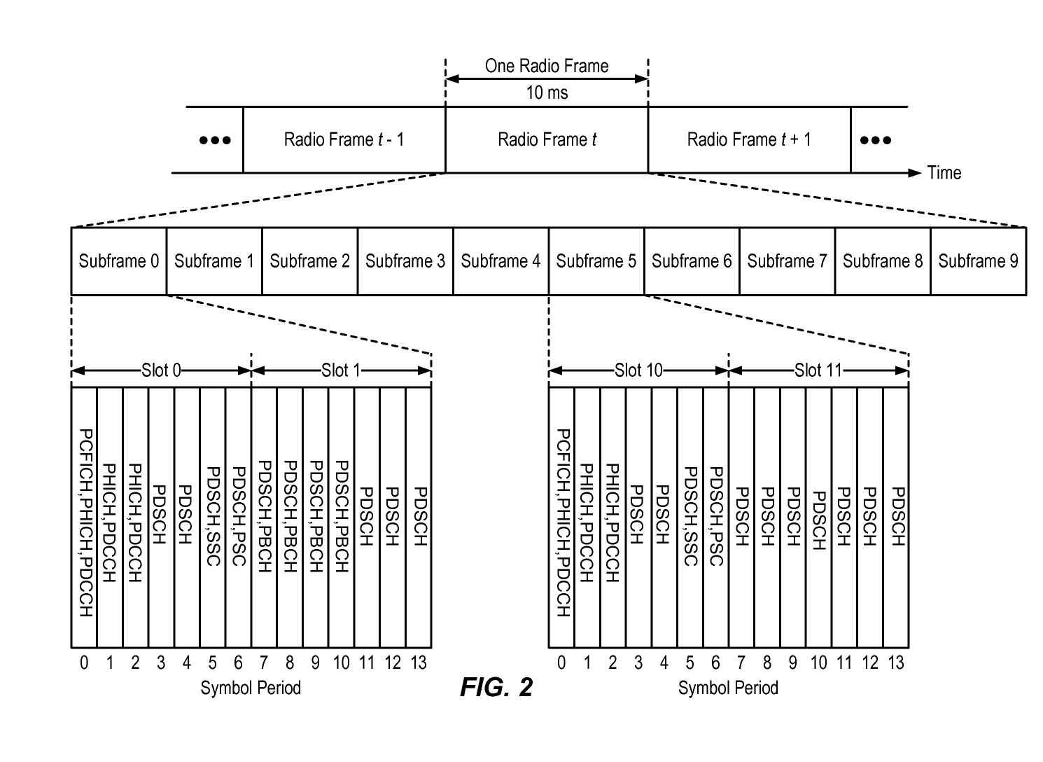

FIG. 2 shows a downlink FDD frame structure used in LTE/-A. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 14 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE/-A, an eNodeB may send a primary synchronization signal (PSC or PSS) and a secondary synchronization signal (SSC or SSS) for each cell in the eNodeB. For FDD mode of operation, the primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. For FDD mode of operation, the eNodeB may send a Physical Broadcast Channel (PBCH) in symbol periods 0 to 3 in slot 1 of subframe 0. The PBCH may carry certain system information.

The eNodeB may send a Physical Control Format Indicator Channel (PCFICH) in the first symbol period of each subframe, as seen in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNodeB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 2. The PHICH may carry information to support hybrid automatic retransmission (HARQ). The PDCCH may carry information on uplink and downlink resource allocation for UEs and power control information for uplink channels. The eNodeB may send a Physical Downlink Shared Channel (PDSCH) in the remaining symbol periods of each subframe. The PDSCH may carry data for UEs scheduled for data transmission on the downlink.

The eNodeB may send the PSC, SSC and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to specific UEs in specific portions of the system bandwidth. The eNodeB may send the PSC, SSC, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. For symbols that are used for control channels, the resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 36 or 72 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNodeB may send the PDCCH to the UE in any of the combinations that the UE will search.

A UE may be within the coverage of multiple eNodeBs. One of these eNodeBs may be selected to serve the UE. The serving eNodeB may be selected based on various criteria such as received power, path loss, signal-to-noise ratio (SNR), etc.

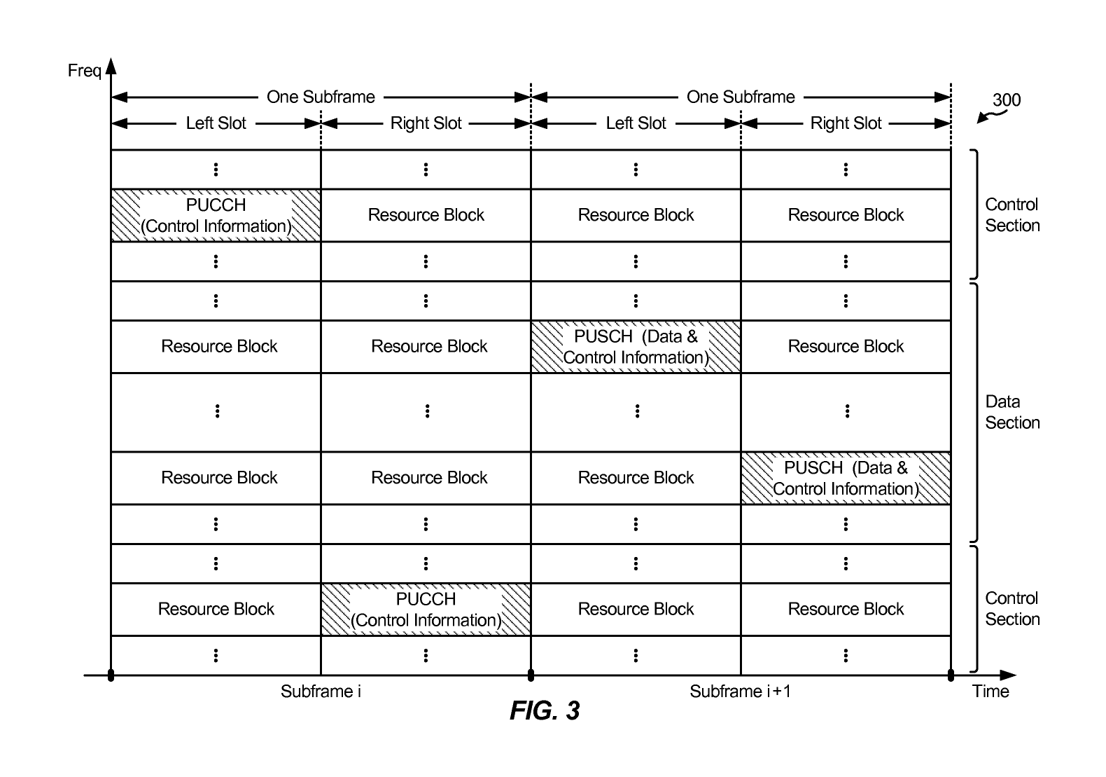

FIG. 3 is a block diagram illustrating an exemplary FDD and TDD (non-special subframe only) subframe structure in uplink long term evolution (LTE) communications. The available resource blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 3 results in the data section including contiguous subcarriers, which may allow a single UE to be assigned all of the contiguous subcarriers in the data section.

A UE may be assigned resource blocks in the control section to transmit control information to an eNodeB. The UE may also be assigned resource blocks in the data section to transmit data to the eNode B. The UE may transmit control information in a Physical Uplink Control Channel (PUCCH) on the assigned resource blocks in the control section. The UE may transmit only data or both data and control information in a Physical Uplink Shared Channel (PUSCH) on the assigned resource blocks in the data section. An uplink transmission may span both slots of a subframe and may hop across frequency as shown in FIG. 3. According to one aspect, in relaxed single carrier operation, parallel channels may be transmitted on the UL resources. For example, a control and a data channel, parallel control channels, and parallel data channels may be transmitted by a UE.

The PSC, SSC, CRS, PBCH, PUCCH, PUSCH, and other such signals and channels used in LTE/-A are described in 3GPP TS 36.211, entitled “Evolved Universal Terrestrial Radio Access (E-UTRA); Physical Channels and Modulation,” which is publicly available.

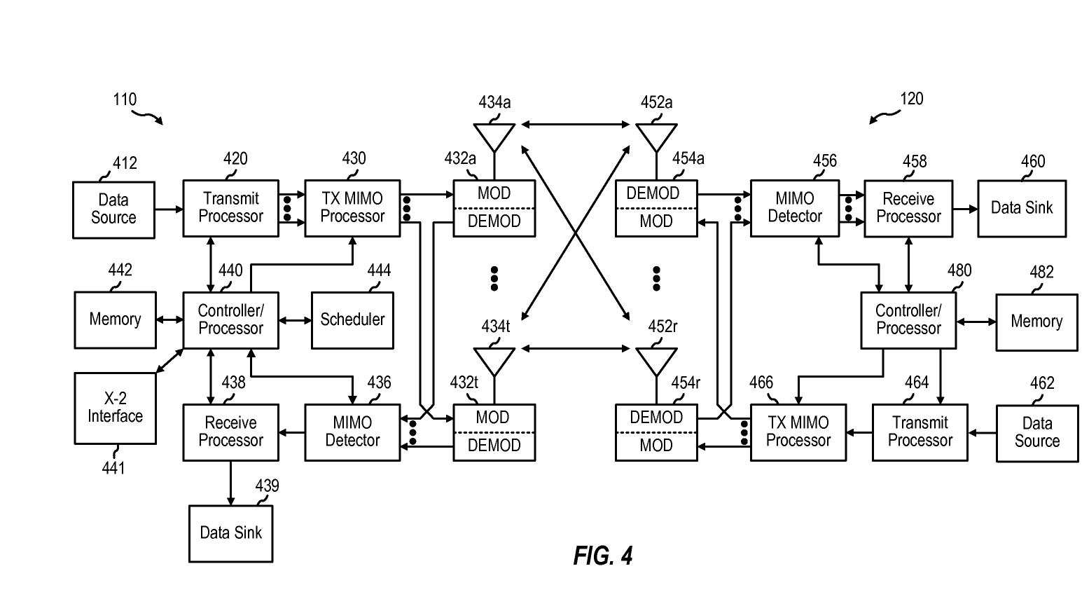

FIG. 4 shows a block diagram of a design of a base station/eNodeB 110 and a UE 120, which may be one of the base stations/eNodeBs and one of the UEs in FIG. 1. The base station 110 may be the macro eNodeB 110c in FIG. 1, and the UE 120 may be the UE 120y. The base station 110 may also be a base station of some other type. The base station 110 may be equipped with antennas 434a through 434t, and the UE 120 may be equipped with antennas 452a through 452r.

At the base station 110, a transmit processor 420 may receive data from a data source 412 and control information from a controller/processor 440. The control information may be for the PBCH, PCFICH, PHICH, PDCCH, etc. The data may be for the PDSCH, etc. The processor 420 may process (e.g., encode and symbol map) the data and control information to obtain data symbols and control symbols, respectively. The processor 420 may also generate reference symbols, e.g., for the PSS, SSS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the PUSCH) from a data source 462 and control information (e.g., for the PUCCH) from the controller/processor 480. The processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the base station 110. At the base station 110, the uplink signals from the UE 120 may be received by the antennas 434, processed by the modulators 432, detected by a MIMO detector 436 if applicable, and further processed by a receive processor 438 to obtain decoded data and control information sent by the UE 120. The processor 438 may provide the decoded data to a data sink 439 and the decoded control information to the controller/processor 440. The base station 110 can send forward handover control messages to other base stations, for example, over an X2 interface 441.

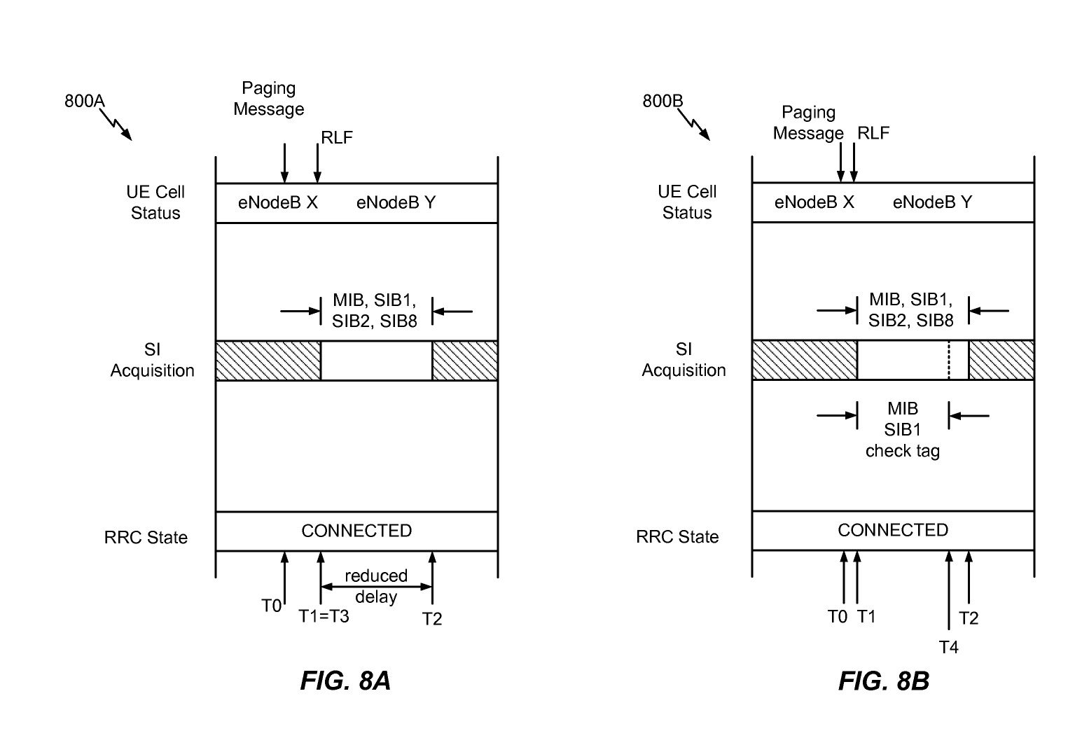

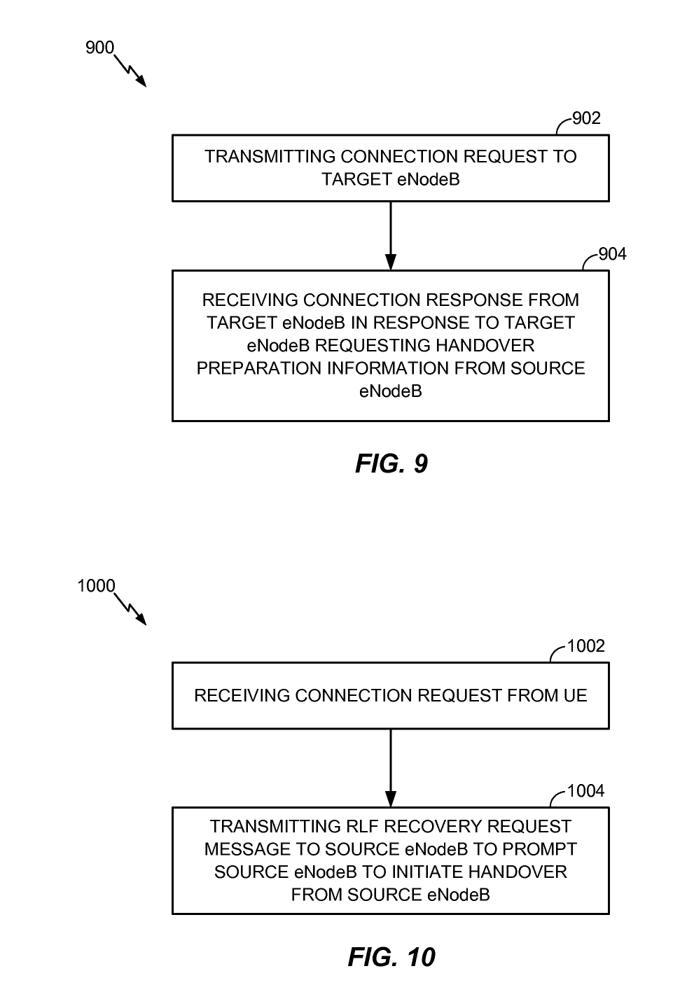

The controllers/processors 440 and 480 may direct the operation at the base station 110 and the UE 120, respectively. The processor 440 and/or other processors and modules at the base station 110 may perform or direct the execution of various processes for the techniques described herein. The processor 480 and/or other processors and modules at the UE 120 may also perform or direct the execution of the functional blocks illustrated in FIGS. 9 and 10, and/or other processes for the techniques described herein. The memories 442 and 482 may store data and program codes for the base station 110 and the UE 120, respectively. A scheduler 444 may schedule UEs for data transmission on the downlink and/or uplink.

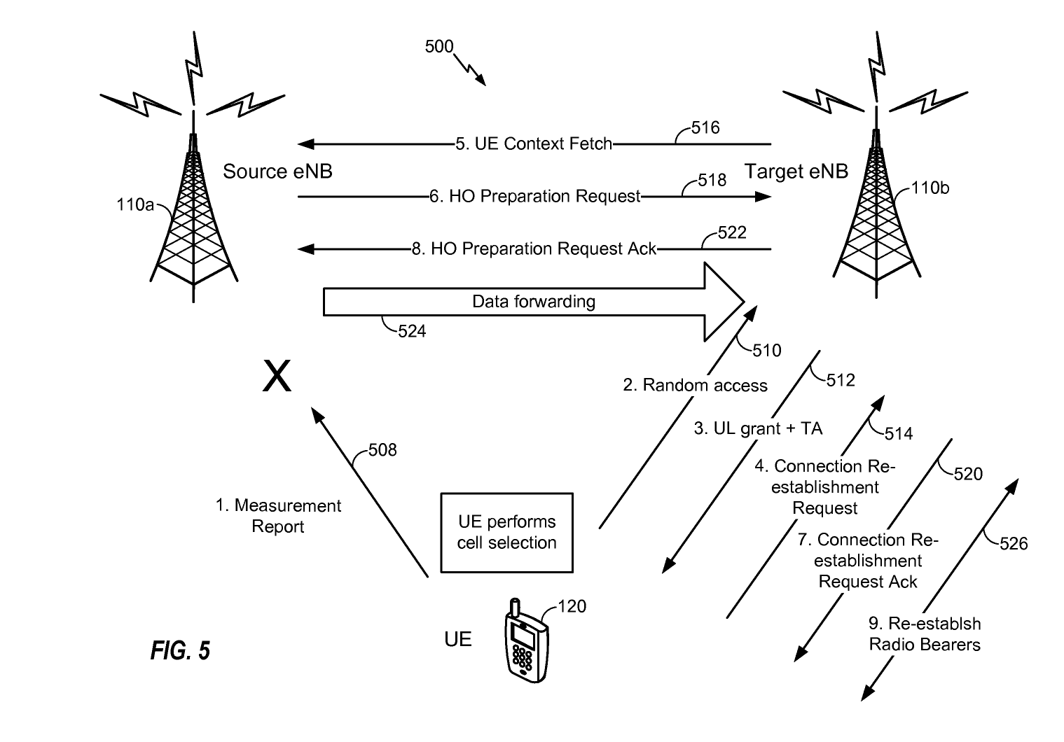

FIG. 5 illustrates a system 500 that performs forward handover from a source eNodeB 110a to a target eNodeB 110b when the source eNodeB 110a cannot receive a measurement report from a related UE 120. Moreover, the UE 120 does not receive downlink communications from the source eNodeB 110a. In one aspect, the system 500 includes a UE 120 that communicates with a source eNodeB 110a to receive access to a wireless network. The system 500 also includes a target eNodeB 110b to which the UE 120 can perform a forward handover to continue receiving access to the wireless network after the UE 120 loses connectivity with the source eNodeB 110a. The UE 120 may be any type of mobile device that receives access to a wireless network. Optionally, the UE 120 may be a mobile base station, relay node, a tethered device, such as a modem, and/or the like. The source eNodeB 110a and/or the target eNodeB 110b may be macro cell access points, femtocell access points, pico cell access points, relay nodes, mobile base stations, and/or substantially any devices that provide access to a wireless network.

In one aspect, the UE 120 transmits measurement reports to the source eNodeB 110a to facilitate handover when one or more metrics (e.g., signal to noise ratio) related to a target eNodeB 110b exceed a threshold. In the example depicted in FIG. 5, the UE 120 transmits a measurement report 508 to the source eNodeB 110a, and the source eNodeB 110a fails to receive the measurement report 508 due to degraded radio conditions or connection, link failure, and/or the like. In one aspect, the radio conditions have degraded rapidly, such as in a sudden loss of line of sight (e.g., when turning around a corner and a large structure such as a building blocks radio signals). In this case, the source eNodeB 110a does not have the information required in order to make a decision to prepare the target eNodeB 110b for backward handover of the UE 120 to the target eNodeB 110b before losing the connection.

The UE 120 may experience Radio Link Failure (RLF) due to the failed transmission of the measurement report 508 to the source eNodeB 110a and can transmit a random access request 510 to the target eNodeB 110b. The target eNodeB 110b may have been selected because it has the best metric (e.g., SNR (signal to noise ratio)) according to the measurement report. The target eNodeB 110b can transmit an uplink (UL) resource grant and TA (Time Alignment) message 510 to the UE 120, which the UE 120 can then use to request connection reestablishment 514 with the target eNodeB 110b. In this example, the target eNodeB 110b was not prepared for the handover by the source eNodeB 110a because the source eNodeB 110a lost connection with the UE 120 and did not receive a measurement report 508.

Thus, the target eNodeB 110b can initiate a procedure to have the source eNodeB 110a prepare the target eNodeB 110b. In one embodiment, an X2 procedure begins with the target eNodeB 110b transmitting to the source eNodeB 110a a UE context fetch 516 for the UE 120 in order to trigger handover preparation. In one aspect, the target eNodeB 110b determines the source eNodeB 110a for the UE 120 according to an identifier in one or more messages from the UE 120. The target eNodeB 110b may transmit the UE context fetch 516 to the source eNodeB 110a over an X2 interface.

In response to receiving the UE connect fetch message, the source eNodeB 110a can transmit a handover preparation request 518 to the target eNodeB 110b to initiate a handover preparation procedure. The target eNodeB 110b can also transmit a connection reestablishment acknowledgement 520 to the UE 120. In addition, the target eNodeB 110b acknowledges the handover preparation request 522. Unlike the case for conventional handovers, such as backward handover and RLF handover, the target eNodeB does not include a ‘transparent container’ in the acknowledgement, (where the ‘transparent container’ comprises a ‘handover command’ message that the source eNodeB would then transmit to the UE). Since the source eNodeB did not receive a measurement report from the UE, the source eNodeB did not make a decision to ‘handover’ the UE to the target eNodeB and consequently the source eNodeB was unable to prepare the target eNodeB for the handover in advance. Therefore, there is no need for the target eNodeB to include the ‘transparent container’ in the acknowledgement to the handover preparation request. Subsequently, the source eNodeB 110a forwards handover data 524 to the target eNodeB 110b, such as the UE context information, EPS bearer information, buffer contents, and/or the like, as with conventional handovers (e.g., backward handover and RLF handover). The target eNodeB 110b can reestablish radio bearers with the UE 120 to complete handover and begin communicating with the UE 120 to provide network access 526.

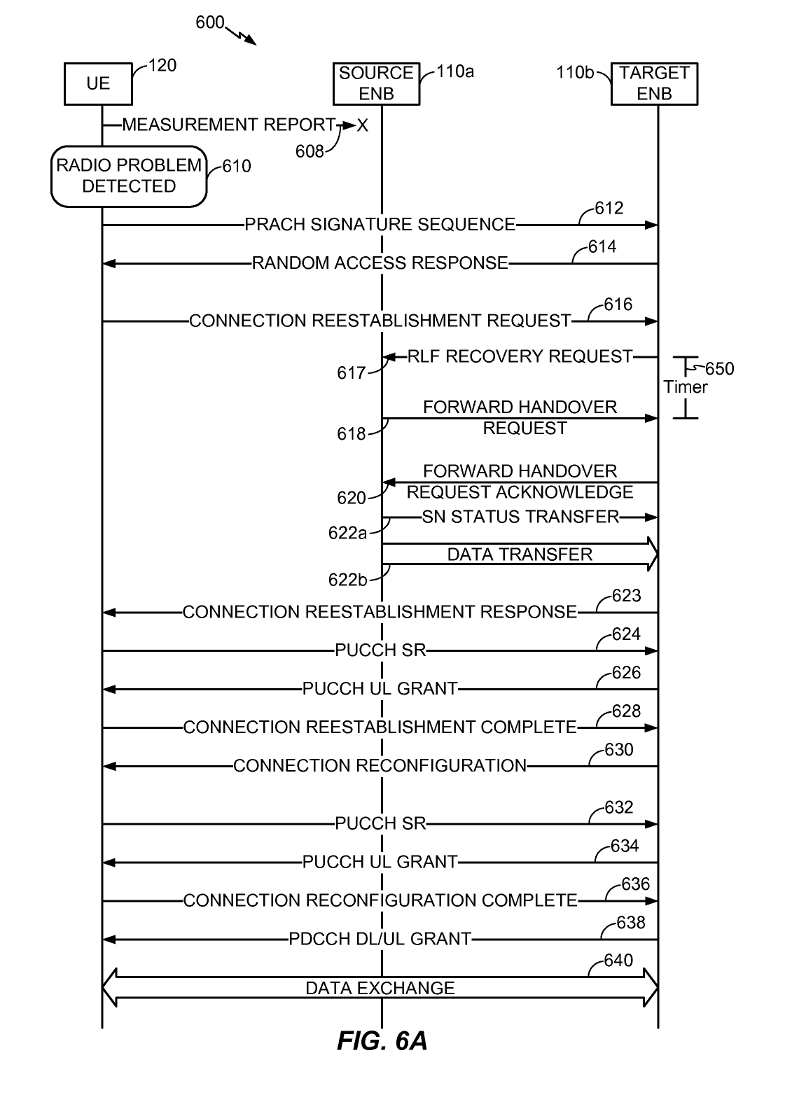

A more detailed explanation of an exemplary forward handover is described with respect to FIG. 6A. FIG. 6A illustrates an example system 600 that performs a successful access procedure related to forward handover of a UE to a target access point. The system 600 includes a UE 120 that receives access from a source eNodeB 110a, and a target eNodeB 110b which receives the UE 120 communications in a forward handover procedure. The UE 120 sends uplink data and receives downlink data on a default EPS (evolved packet system) bearer and, optionally, on one or more dedicated EPS bearers via the current serving cell belonging to the source eNodeB 110a. The UE 120 sends a measurement report at time 608 to the source eNodeB 110a. In one example, the measurement report is not received at the source eNodeB 110a due to degraded radio conditions. At time 610, the UE 120 detects physical layer problems and starts a timer. If the UE does not recover from the detected physical layer problems before the timer expires, then the UE 120 also declares RLF (radio link failure) and starts a second timer and suspends SRB1 (signal radio bearer 1), SRB2 and all DRBs (dedicated radio bearers). The UE 120 then selects a target eNodeB 110b to access. At time 612, the UE 120 then transmits a PRACH (physical random access channel) signature sequence to the target eNodeB 110b. At time 614 the target eNodeB 110b transmits a random access response to the UE 120, which can include resources over which the UE 120 can request a connection to the target eNodeB 110b.

The UE 120 transmits a connection reestablishment request at time 616 over the resources (e.g., an RRCConnectionReestablishmentRequest). The target eNodeB 110b, cannot locate the UE 120 context because the handover was not prepared by the source eNodeB 110a. Thus, the target eNodeB 110b sends a RLF RECOVERY REQUEST message at time 617 to the source eNodeB 110a in order to fetch the UE's context in the source eNodeB. The message can include the target eNodeB ID, target cell information, and/or the UE identity. The target eNodeB 110b also starts the timer T_X2RLFRecoveryReq 650. Upon receiving the RLF RECOVERY REQUEST message from the target eNodeB 110b, the source eNodeB 110a locates the UE's context and decides that it can request the preparation of resources in the target eNodeB for a forward handover. The source eNodeB 110a then sends a FORWARD HANDOVER REQUEST message at time 618 to the target eNodeB 110b over the X2 interface. The target eNodeB 110b receives the FORWARD HANDOVER REQUEST message and determines it can establish UE context. Upon receiving the FORWARD HANDOVER REQUEST message, the target eNodeB 110b stops the timer T_X2RLFRecoveryReq 650. If the FORWARD HANDOVER REQUEST message, however, is not received before the timer T_X2RLFRecoveryReq 650 expires, the forward handover is deemed unsuccessful and the process terminates with the target eNodeB rejecting the UE's connection reestablishment request (e.g., by sending an RRCConnectionReestablishmentReject message to the UE). The UE then transitions from RRC_CONNECTED state to RRC_IDLE state and attempts to access the target eNodeB using the NAS recovery procedure defined in the 3GPP specifications (this would result in a loss of all UE's unackowledged data in the source eNodeB in addition to a longer delay before service can be restored).

Assuming successful receiving of the FORWARD HANDOVER REQUEST message, the target eNodeB 110b then sends a FORWARD HANDOVER REQUEST ACKNOWLEDGE message at time 620 to the source eNodeB 110a. The message may include source eNodeB identification information, target eNodeB identification information and/or a list of EPS bearers setup. Unlike the case for conventional handovers like backward handover and RLF handover, the target eNodeB does not need to include a ‘transparent container’ in the acknowledgement since the source eNodeB does not need to transmit the ‘transparent container’ containing a ‘handover command’ to the UE. In one aspect of the disclosure, at time 620, the target eNodeB 110b may also send a PATH SWITCH REQUEST message (not shown) to the mobile management entity (MME) (not shown). The message directs the MME to instruct a serving gateway (S-GW) (not shown) to send future downlink data intended for the UE to the target eNodeB 110b so the source eNodeB 110a does not relay data to the target eNodeB 110b after the handover. The message also instructs the serving gateway to receive future uplink data (from the UE) directly from the target eNodeB instead of the source eNodeB. The PATH SWITCH REQUEST message (not shown) may be transmitted at time 620. Optionally, in another embodiment, the PATH SWITCH REQUEST message may occur some time later than time 620 and before time 640. Also, upon receiving the FORWARD HANDOVER REQUEST ACKNOWLEDGE message from the target eNode, the source eNodeB may send a Sequence Number (SN) STATUS TRANSFER message at time 622a to the target eNodeB. The SN STATUS TRANSFER message may include sequence numbers of unacknowledged downlink data and optionally may include sequence numbers of uplink data. This allows forward handover to provide lossless, in-order delivery of data. Additionally, at time 622b, the source eNodeB forwards data to the target eNodeB, such as the UE's unacknowledged downlink data and may optionally forward uplink data.

The target eNodeB 110b then sends a connection reestablishment response at time 623 (e.g., RRCConnectionReestablishmentResponse) to the UE 120 to indicate successful connection establishment. The message may contain dedicated radio resource configuration information for signal radio bearer 1 (SRB1). The UE 120 transmits a PUCCH SR (physical uplink control channel scheduling request) at time 624 to the target eNodeB 110b, which can allocate uplink resources for the UE 120. The target eNodeB 110b transmits a PUCCH uplink grant to the UE 120 at time 626. Upon receiving the control resources, the UE 120 can acknowledge setup of the signaling radio bearer by transmitting a connection reestablishment complete message at time 628 (e.g., RRC Connection Reestablishment Complete) to the target eNodeB 110b. The target eNodeB 110b transmits a connection reconfiguration message at time 630 (e.g., RRCConnectionReconfiguration) to the UE 120 to setup another signaling radio bearer and one or more data radio bearers (i.e., the target eNodeB restores the UE's context that the target eNodeB retrieved from the source eNodeB to the extent that there are sufficient target eNodeB resources for the UE's previous data radio bearers).

The UE 120 transmits another PUCCH SR (control channel schedule request) at time 632, for example, and the target eNodeB 110b can respond with a PUCCH uplink grant at time 634 for additional control resources. Upon receiving the control resources, the UE 120 acknowledges setup of the additional signaling radio bearer and one or more data radio bearers by transmitting a connection reconfiguration complete message at time 636 (e.g., RRCConnectionReconfigurationComplete) to the target eNodeB 110b. Subsequently, the target eNodeB 110b transmits a PDCCH downlink/uplink grant at time 638 to the UE 120 allowing the UE to transmit user plane data to and receive user plane data from the target eNodeB 110b completing the forward handover. The UE 120 and the target eNodeB 110b can exchange data at time 640.

In another aspect of the present disclosure, as seen in FIG. 6B, the forward handover of the UE 120 to a target eNodeB 110b is an unsuccessful operation. In one scenario, forward handover is unsuccessful because the source eNodeB 110a rejects a request from the target eNodeB 110b. More particularly, at time 617 the target eNodeB 110b sends a RLF RECOVERY REQUEST message to the source eNodeB 110a. The target eNodeB 110b also starts the timer T_X2RLFRecoveryReq 650. Upon receiving the RLF RECOVERY REQUEST message from the target eNodeB 110b, the source eNodeB 110a rejects the request, for example when the source eNodeB 110a cannot locate the UE's context and decides that it cannot request the preparation of resources in the target eNodeB 110b for forward handover. The source eNodeB 110a then sends a RLF RECOVERY REJECT message at time 619 to the target eNodeB 110b. The message may include a cause indication (e.g., UE context unknown). Upon receiving the RLF RECOVERY REJECT message, the target eNodeB 110b stops the timer T_X2RLFRecoveryReq 650. The target eNodeB then rejects the UE's connection reestablishment request (e.g., by sending an RRCConnectionReestablishmentReject message to the UE). The UE then transitions from RRC_CONNECTED state to RRC_IDLE state and attempts to access the target eNodeB using the NAS recovery procedure defined in the 3GPP specifications. This may result in a loss of all UE's unackowledged data in the source eNodeB in addition to a longer delay before service can be restored).

In another scenario illustrated in FIG. 6C, forward handover is unsuccessful because the target eNodeB 110b rejects a request from the source eNodeB 110a. More particularly, at time 617 the target eNodeB 110b sends a RLF RECOVERY REQUEST message to the source eNodeB 110a and starts the timer T_X2RLFRecoveryReq 650. Upon receiving the RLF RECOVERY REQUEST message from the target eNodeB 110b, the source eNodeB 110a locates the UE's context and decides it can request the preparation of resources in the target eNodeB 110b for forward handover. The source eNodeB 110a then sends a FORWARD HANDOVER REQUEST message to the target eNodeB 110b at time 620 and also stops the timer T_X2RLFRecoveryReq 650. Upon receiving the message, the target eNodeB 110b rejects the forward handover, for example the target eNodeB 110b decides it cannot establish the UE context (e.g., the target eNodeB does not have sufficient radio resources available). Then at time 621, the target eNodeB 110b sends a FORWARD HANDOVER PREPARATION FAILURE message to the source eNodeB 110a. The message may contain a cause indication (e.g., insufficient radio resources, etc.).

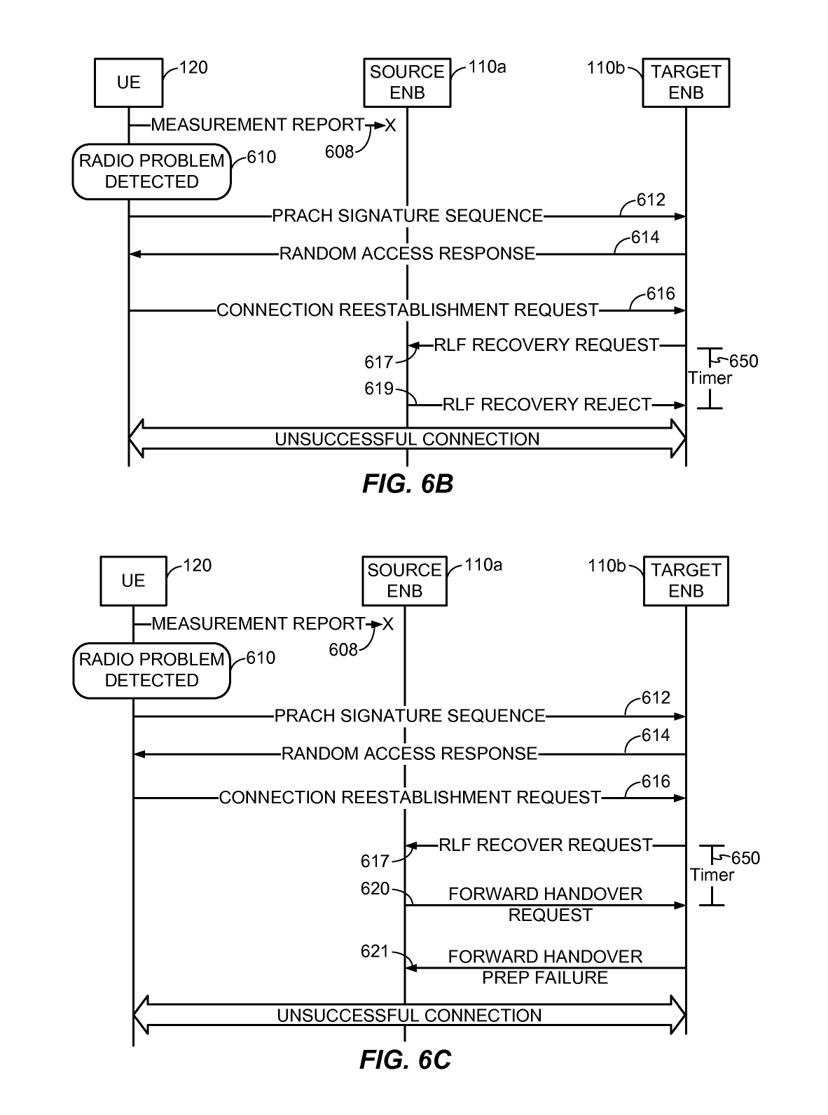

FIG. 7 illustrates a system 700 that facilitates forward handover in wireless communications. In one embodiment, the components illustrated in FIG. 7 would reside in radio resource management (RRM) software in the controller processor 440 and/or scheduler 444 of the system illustrated in FIG. 4. The system 700 includes a wireless device 120, which may be a UE or other mobile device (e.g., relay node, mobile base station, etc.) that receives access to a wireless network through one or more disparate devices. The system 700 also includes a source access point 110a and a target access point 110b that may be eNodeBs, base stations, femtocell access points, picocell access points, mobile base stations, mobile devices operating in a peer-to-peer communications mode, and/or the like, for example, that provide a wireless device 120, and/or one or more wireless devices, with access to a wireless network. In addition, the source access point 110a and the target access point 110b can communicate over a backhaul connection, over-the-air, via one or more network devices. In one example, the source access point 110a includes the components shown and described in the target access point 110b, and vice versa, to facilitate similar functionality.

The source access point 110a may include a device communicating component 708 that assigns resources to and communicates with one or more wireless devices, a handover request receiving component 710 that obtains a handover request from another access point to facilitate forward handover, a handover preparation requesting component 712 that transmits a handover preparation request to another access point, and a handover data component 714 that transmits one or more parameters related to communicating with a wireless device to another disparate access point.

The target access point 110b includes a device communicating component 716 that facilitates communicating with one or more wireless devices through resources assigned thereto, a forward handover requesting component 718 that submits a request for handover of communication for a wireless device to a source access point, a handover preparation request receiving component 720 that obtains a handover preparation request from a source access point, a handover preparation request acknowledging component 722 that transmits an acknowledgement related to a handover preparation request to a source access point, and a handover data receiving component 724 that obtains one or more parameters related to communicating with a wireless device.

The wireless device 120 can include a measurement report component 726 that generates measurement reports based at least in part on measuring one or more metrics of one or more neighboring access points, a connection viability detecting component 728 that can determine a status of a radio connection with a source access point (e.g., whether the connection is active, failed, etc.), and a connection establishing component 730 that can perform various operations to receive access to an access point.

According to an example, the wireless device 120 can receive wireless network access from the source access point 110a, communicating through the device communicating component 708. For example, the connection establishing component 730 can have established a connection with the source access point 110a (e.g., via random access procedure, RRC (radio resource control) connection establishment procedures), and the device communicating component 708 may allocate and assign uplink/downlink communication resources to the wireless device 120. The measurement report component 726 may determine one or more communication metrics of one or more neighboring access points (e.g., SNR), and can formulate and transmit a measurement report to the source access point 110a. If an access point in the measurement report appears desirable for handover (e.g., its one or more metrics are beyond a threshold), the source access point 110a can facilitate a backward handover to the access points.

In one example embodiment, the radio communication quality can rapidly degrade to a point that the device communicating component 708 cannot receive a measurement report from the measurement report component 726. A connection viability detecting component 728 can determine that the radio connection with source access point 110a is degraded beyond a threshold and/or that the source access point 110a did not receive a previous measurement report. The connection establishing component 730 can request network access from the target access point 110b through the device communicating component 716. This can include, for example, transmitting a random access preamble to the target access point 110b. In one example, the device communicating component 716 can grant resources to the wireless device 120, over which connection establishing component 730 can transmit a connection reestablishment request. Because target access point 110b is not prepared to communicate with the wireless device 120 in a handover scenario, the forward handover requesting component 718 can request handover information from the source access point 110a.

The handover request receiving component 710 can obtain the handover information request, and the handover preparation requesting component 712 can transmit a handover request preparation message to the target access point 110b. The handover preparation request receiving component 720 can obtain the request, and acknowledge handover preparation through the handover preparation request acknowledging component 722 transmitting an acknowledgement to the source access point 110a. Subsequently, the handover data component 714 can transmit handover information related to the wireless device 120 to the target access point 110b. For example, the forward handover requesting component 718 can identify the wireless device 120 in the request for handover information. In one example, the forward handover requesting component 718 may identify the source access point 110a for requesting handover information based on messages received from the wireless device 120.

The device communicating component 716 can also acknowledge connection reestablishment to the wireless device 120. The handover data receiving component 724 can obtain the handover information, which can include a context of the wireless device 120, EPS (evolved packet system) bearer information, and/or buffer contents related to previous communications with the wireless device 120. Once this handover information is received, for example, the device communicating component 716 can reestablish radio bearers with the wireless device 120 and assign resources thereto for subsequent wireless network communications. Thus, the wireless device 120 can be handed over to the target access point 110b without the source access point 110a first preparing the target access point 110b for handover.

In one embodiment, a UE applies a system information acquisition procedure to acquire the access stratum (AS) and non-access stratum (NAS) system information that is broadcasted by the Evolved Universal Terrestrial Radio Access Network (E-UTRAN). The procedure applies to UEs in the RRC_IDLE state and UEs in the RRC_CONNECTED state. When a UE is in the RRC_CONNECTED state, the UE ensures that it has a valid version of the MasterinformationBlock (MIB), SystemInformationBlockType1 (SIB1), SystemInformationBlockType2 (SIB2), and SystemInformationBlockType8 (SIB8) when CDMA2000 is supported. This minimal set of system information is sufficient for the UE to stay on the cell in the RRC_CONNECTED state. The UE deletes any stored system information after three hours, for example, from the moment the system information was confirmed valid. The procedure applies to UEs in the RRC_CONNECTED state following (1) handover completion; (2) cell selection (recovery after RLF before timer expiry); and (3) notification that the system information has changed.

In one embodiment, When the UE 120 is in the RRC_CONNECTED state, the UE 120 ensures that it has a valid version of the MIB, SIB1, SIB2, and SIB8 if CDMA2000 is supported. SIB1 includes a value tag, systemInfoValueTag, that indicates if a change has occurred in the system information messages SIB2 through SIB12. The UEs may use the value tag to verify if previously stored system information messages are still valid. UEs consider system information to be invalid after three hours (for example) from the moment the system information was confirmed valid.

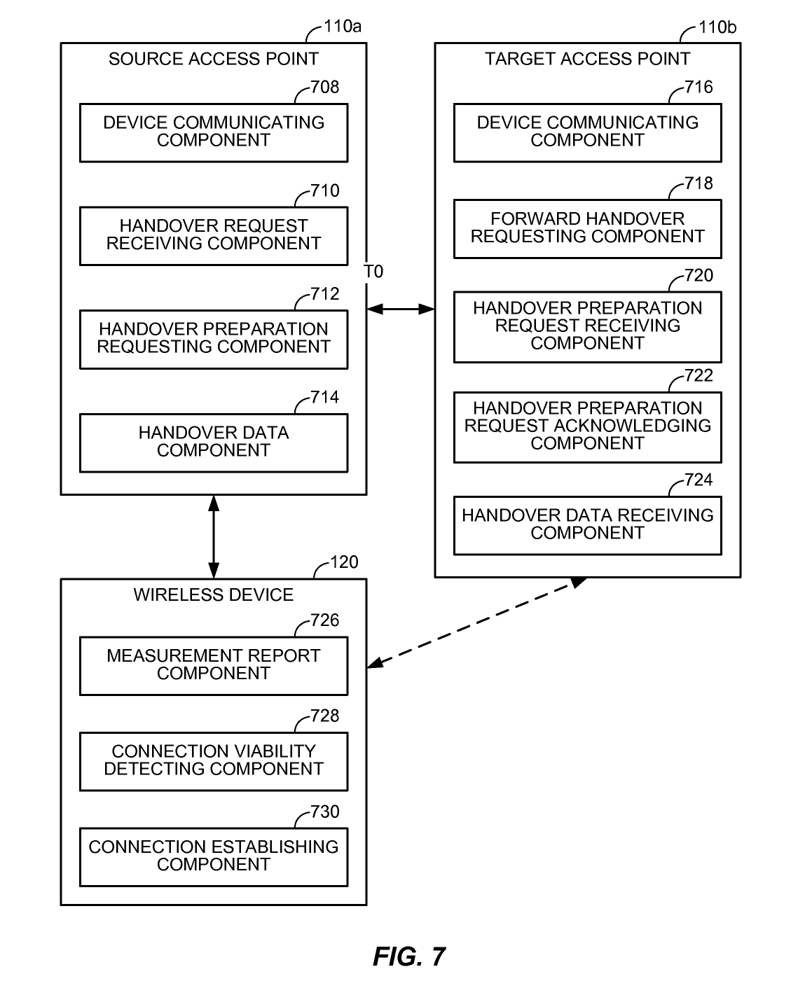

FIG. 8A is a timing diagram 800A illustrating a reduced delay in the system information acquisition procedure according to an aspect of the present disclosure. The UE periodically receives a paging message, for example at time T0. The paging message informs the UE about a system information change for the source eNodeB. According to an aspect of the present disclosure, the paging message includes information about whether system information has changed for neighbor eNodeBs. For example, the paging message may include an additional flag indicating whether the system information has changed for any of the neighboring eNodeBs, such as, for example, eNodeB X or eNodeB Y.

Before time T1, the UE is camped on eNodeB X. At time T1, due to the RLF (radio link failure), the UE initiates a system information acquisition procedure on eNodeB Y in order to recover from the RLF declared at time T1. When the UE is in the RRC_CONNECTED state and acquires the system information to recover from the RLF, the UE collects the MIB, SIB1, SIB2, and SIB8 (assuming CDMA2000 is supported). This reduced set of “required” system information is sufficient for the UE to stay in the RRC_CONNECTED state. Acquisition of the MIB, SIB1, SIB2, and SIB8 is completed at time T2. At time T2 the UE may then connect to the neighbor eNodeB Y.

However, if the additional flag in the paging message does not indicate the system information has changed for a neighbor eNodeB Y, and the system information for eNodeB Y is current (for example less than 3 hours old), the UE assumes that the system information for neighbor eNodeB Y has not changed. Accordingly, the UE does not acquire system information, e.g., MIB, SIB1, SIB2, and SIB8 (however, the MIB may need to be decoded, regardless, in order to obtain the SFN (System Frame Number)). As such, the system information acquisition procedure is completed at time T3, which is equal to time T1. The UE can then at time T1 connect to the neighbor eNodeB Y. Accordingly, a reduced delay for RLF recovery is achieved. The time savings is time T2-time T3.

FIG. 8B is another timing diagram 800B illustrating the system information acquisition procedure according to another aspect of the present disclosure. If the additional flag in the paging message received at time T0 indicates that system information for a neighbor eNodeB has changed, then the UE acquires the MIB and SIB1 and checks the value tag in the SIB1 at time T1 to determine if the system information has actually changed for eNodeB Y. If the value tag indicates the system information has not changed for eNodeB Y, the system information acquisition procedure completes at time T4. Otherwise, if the value tag indicates the system information has changed for eNodeB Y, the UE acquires the additional system information, SIB2 and SIB8 if CDMA2000 is supported, and therefore the system information acquisition procedure is completed at time T2.

FIG. 9 is an example block diagram illustrating a method of forward handover. In the example method 900, the UE 120 transmits a connection request to a target eNodeB 110b at block 902. Next, in block 904, the UE 120 receives a connection response from the target eNodeB 110b as a result of the target eNodeB 110b requesting handover preparation information from a source eNodeB 110a.

FIG. 10 is an example block diagram illustrating a method of forward handover. In the example method 1000, a target eNodeB 110b receives a connection request from a UE 120, at block 1002. Next, in block 1004, the target eNodeB 110b transmits a radio link failure recovery request message to a source eNodeB 110a to prompt the source eNodeB to initiate handover of the UE from the source eNodeB.

In one configuration, the UE 120 is configured for wireless communication including means for transmitting a connection request to the target eNodeB. In one aspect, the transmitting means may be the controller/processor 480, the memory 482, the transmit processor 464, modulators 454A-454R,and the antennas 452A-452R, configured to perform the functions recited by the transmitting means. The UE 120 is also configured to include a means for receiving a connection response from the target eNodeB. In one aspect, the receiving means may be the processor(s), the controller/processor 480, the memory 482, the receive processor 458, the demodulators 454A and 454T, and the antennas 452A-452R, configured to perform the functions recited by the receiving means. In another aspect, the aforementioned means may be a module or any apparatus configured to perform the functions recited by the aforementioned means.

In one configuration, an eNodeB 110 is configured for wireless communication including means for receiving a connection request. In one aspect, the receiving means may be the controller/processor 440, the memory 442, the receive processor 438, the demodulators 432A-432T, and the antennas 434A-434T configured to perform the functions recited by the receiving means. The eNodeB 110 is also configured to include a means for transmitting an RLF Request message. In one aspect, the transmitting means may be the controller/processor 440, the memory 442, and the X-2 interface 441 configured to perform the functions recited by the transmitting means. In another aspect, the aforementioned means may be a module or any apparatus configured to perform the functions recited by the aforementioned means.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
transmitting a connection request to a target eNodeB; and
receiving a connection response from the target eNodeB in response to the target eNodeB requesting handover preparation information from a source eNodeB.

2. The method of claim 1, further comprising:
transmitting a measurement report to the source eNodeB, prior to transmitting the connection request; and
detecting a connection failure with the source eNodeB.

3. The method of claim 1, further comprising:
receiving an indication of whether system information of a target eNodeB has changed; and
communicating with the target eNodeB using previously stored system information when the indication indicates the system information has not changed.

4. A method of wireless communication, comprising:
receiving a connection request from a user equipment (UE); and
transmitting a radio link failure (RLF) recovery request message to a source eNodeB to prompt the source eNodeB to initiate handover of the UE from the source eNodeB.

5. The method of claim 4, further comprising:
receiving a handover request message from the source eNodeB in response to the RLF recovery request message; and
transmitting an uplink grant to the UE.

6. An apparatus for wireless communication comprising:
a memory, and
at least one processor coupled to the memory, the at least one processor, being configured:
to transmit a connection request to a target eNodeB; and
to receive a connection response from the target eNodeB in response to the target eNodeB requesting handover preparation information from a source eNodeB.

7. The apparatus of claim 6, in which the at least one processor is further configured:
to transmit a measurement report to the source eNodeB, prior to transmitting the connection request; and
to detect a connection failure with the source eNodeB.

8. The apparatus of claim 6, in which the at least one processor is further configured:
to receive an indication of whether system information of a target eNodeB has changed; and
to communicate with the target eNodeB using previously stored system information when the indication indicates the system information has not changed.

9. An apparatus for wireless communication comprising:
a memory, and
at least one processor coupled to the memory, the at least one processor being configured:
to receive a connection request from a user equipment (UE); and
to transmit a radio link failure (RLF) recovery request message to a source eNodeB to prompt the source eNodeB to initiate handover of the UE from the source eNodeB.

10. The apparatus of claim 9, in which the at least one processor is further configured:
to receive a handover request message from the source eNodeB in response to the RLF recovery request message; and
to transmit an uplink grant to the UE.

11. A system for wireless communication, comprising:
means for transmitting a connection request to a target eNodeB; and
means for receiving a connection response from the target eNodeB in response to the target eNodeB requesting handover preparation information from a source eNodeB.

12. The system of claim 11, further comprising:
means for transmitting a measurement report to the source eNodeB, prior to transmitting the connection request; and
means for detecting a connection failure with the source eNodeB.

13. The system of claim 11, further comprising:
means for receiving an indication of whether system information of a target eNodeB has changed; and
means for communicating with the target eNodeB using previously stored system information when the indication indicates the system information has not changed.

14. A system for wireless communication, comprising:
means for receiving a connection request from a user equipment (UE); and
means for transmitting a radio link failure (RLF) recovery request message to a source eNodeB to prompt the source eNodeB to initiate handover of the UE from the source eNodeB.

15. The system of claim 14, further comprising:
means for receiving a handover request message from the source eNodeB in response to the RLF recovery request message; and
means for transmitting an uplink grant to the UE.

16. A computer program product for wireless communications in a wireless network, comprising:
a computer-readable medium having program code recorded thereon, the program code comprising:
program code to transmit a connection request to a target eNodeB; and
program code to receive a connection response from the target eNodeB in response to the target eNodeB requesting handover preparation information from a source eNodeB.

17. The computer program product of claim 16, in which the program code further comprises:
program code to transmit a measurement report to the source eNodeB, prior to transmitting the connection request; and
program code to detect a connection failure with the source eNodeB.

18. The computer program product of claim 16, in which the program code further comprises:
program code to receive an indication of whether system information of a target eNodeB has changed; and
program code to communicate with the target eNodeB using previously stored system information when the indication indicates the system information has not changed.

19. A computer program product for wireless communications in a wireless network, comprising:
a computer-readable medium having program code recorded thereon, the program code comprising:
program code to receive a connection request from a user equipment (UE); and
program code to transmit a radio link failure recovery request message to a source eNodeB to prompt the source eNodeB to initiate handover of the UE from the source eNodeB.

20. The computer program product of claim 19, in which the program code further comprises:
program code to receive a handover request message from the source eNodeB in response to the RLF recovery request message; and program code to transmit an uplink grant to the UE.
